(19) United States
(12) Patent Application Publication
(10) Pub. No.: US 2025/0042803 A1
(43) Pub. Date: Feb. 6, 2025

(54) GLASS-CERAMIC PLATE

(71) Applicant: EUROKERA S.N.C., CHATEAU-THIERRY (FR)

(72) Inventors: Hélène SERVAIS, AUBERVILLIERS (FR); Jean-Patrick COCHARD, AUBERVILLIERS (FR); Eric JANIAUD, AUBERVILLIERS (FR)

(73) Assignee: EUROKERA S.N.C., CHATEAU-THIERRY (FR)

(21) Appl. No.: 18/720,053

(22) PCT Filed: Dec. 15, 2022
(86) PCT No.: PCT/FR2022/052361

§ 371 Date: Jun. 14, 2024

(30) Foreign Application Priority Data
Dec. 17, 2021 (FR) FR2113829

(51) Int. Cl. C03C 10/00; C03B 32/02

(52) U.S. Cl. CPC C03C 10/0027; C03C 10/0054; C03B 32/02; C03C 2204/00

(57) ABSTRACT

The invention relates to a lithium aluminosilicate-type glass-ceramic plate characterized in that it has a chemical composition comprising the following constituents, within the limits defined below expressed in weight percent
SnO₂ 0.05 to <0.35%
V₂O₅ 0.05 to 0.40%
Fe₂O₃ >0.30 to 0.40%
Cr₂O₃ 0.005 to 0.040%.

The present invention relates to the field of glass-ceramic plates as well as their production methods.

Glass-ceramic plates are produced by subjecting lithium aluminosilicate glass plates to a high-temperature heat treatment, also known as a ceramization cycle. This heat treatment generates crystals of beta-quartz or beta-spodumene structure, with a negative coefficient of thermal expansion, within the plate. The glass-ceramic material is therefore no longer glass: it is made up of crystals linked by a residual vitreous phase, and has a coefficient of thermal expansion close to zero.

Such glass-ceramic plates are used in particular in cooking devices, also known as cooktops. These appliances are often fitted into a worktop or mounted in stoves. Glass-ceramic plates can also be used as worktops. In all cases, the aesthetic appearance of the plate is an important criterion in the consumer's choice.

The glass-ceramic plates used in cooking devices in particular are generally dark glass-ceramics, typically colored with vanadium oxide. They have the distinctive feature of low, or even very low, light transmission, making it possible to conceal internal components such as heaters. Their use in cooking equipment also imposes certain requirements specific to these applications. Good infrared transmission is also necessary for the operation of touch controls (around 950 nm) or radiative heaters (around 2400 nm).

For both functional and aesthetic reasons, cooking devices are generally equipped with displays such as light-emitting diodes (LEDs) or screens. There is a growing market demand for a wider range of choices, particularly from the perspective of aesthetic appeal. In this context, one of the aspects of differentiation adopted is the development of varied aesthetic effects via the use of display means, such as LEDs, visible through the glass-ceramic plates. The properties required of glass-ceramic plates, particularly in terms of light transmission, can thus vary according to the desired effects. Varying the optical properties of a glass-ceramic usually requires adjustments to the composition. The availability of a wide range of glass-ceramic sheets thus entails significant additional production costs, due for example to the transition times required to change composition in the melting furnaces for mother glass production and/or inventory management requirements. There is therefore a need for a mother glass that can be used to produce glass-ceramic plates whose properties, particularly in terms of light transmission, can be modulated to meet a wider range of specifications, without the need to adapt the composition.

Thus, the present invention concerns a lithium aluminosilicate-type glass-ceramic plate, characterized in that it has a chemical composition comprising the following constituents within the limits defined below expressed in weight percent:
SnO₂ 0.05 to <0.35%
V₂O₅ 0.05 to 0.40%
Fe₂O₃ >0.30 to 0.40%
Cr₂O₃ 0.005 to 0.04%.

The present invention also relates to a method for manufacturing a glass-ceramic plate comprising the provision of a lithium aluminosilicate glass plate, known as a mother glass, and the ceramization of the glass plate.

Another object of the present invention is the glass-ceramic precursor plate according to the invention, or mother glass. This glass plate is an intermediate product for obtaining the glass-ceramic plate according to the invention.

For a given composition, there is a ceramization window within which the ceramization parameters (in particular temperature and duration of the ceramization stage) can be modified while ensuring adequate crystallization, giving the glass-ceramic its special mechanical properties, in particular a near-zero coefficient of thermal expansion, typically no more than 15.10⁻⁷ K⁻¹, or even no more than 10.10⁻⁷ K⁻¹, or even no more than 5.10⁻⁷ K⁻¹ between 20 and 700° C. The Applicant has demonstrated that by choosing the SnO₂, V₂O₅, Fe₂O₃ and Cr₂O₃ contents in such a way as to respect the equilibria defined according to the invention, it is possible to obtain, from the same mother glass, glass-ceramics with a wider range of properties, particularly optical properties, while maintaining the requirements needed for the desired applications, particularly in a cooking device. In particular, a wider range of light transmission can be achieved in the ceramization window.

Vanadium oxide (V₂O₅) is a main pigment in glass-ceramics according to the invention. They have a V₂O₅ content of 0.05 to 0.40%, preferably from 0.07 to 0.30%, more preferentially 0.10 to 0.20%. V₂O₅, in the presence of SnO₂, significantly darkens the glass during ceramization. V₂O₅ is responsible for absorption, mainly below 700 nm, and in its presence it is possible to maintain sufficiently high transmission at 950 nm and in the infrared.

The chromium oxide (Cr₂O₃) content ranges from 0.005 to 0.040%, preferably from 0.010 to 0.032%, more preferentially from 0.012 to 0.030%. In some embodiments, the Cr₂O₃ content is 0.010 to 0.025%, or even 0.020%.

Glass-ceramics according to the invention have a total iron oxide content (expressed as Fe₂O₃) strictly greater than 0.30% and up to 0.40%. The Fe₂O₃ content is preferably strictly greater than 0.32% and can be as high as 0.40%. It can be from 0.33 to 0.40%, more preferentially from 0.35 to 0.40%.

The composition contains tin oxide (SnO₂) as a refining agent. The greater the amount of SnO₂ present, the easier and more efficient the refining process. However, it is assumed that SnO₂ also affects coloration by modifying the redox equilibria with vanadium and iron during ceramization. The SnO₂ content is thus from 0.05% to strictly less than 0.35%, preferably from 0.10 to 0.32%, more preferentially from 0.15 to 0.30%.

The SnO₂, V₂O₅ and Fe₂O₃ contents satisfy the following conditions: 14<1000×(2 Fe₂O₃—SnO₂)×V₂O₅/2<40, preferably 20<1000×(2 Fe₂O₃—SnO₂)×V₂O₅/2<35. This balance significantly improves the range of light transmission achievable on the ceramic window.

The SnO₂, V₂O₅ and Fe₂O₃ contents can also satisfy the following conditions: 7.0<Fe₂O₃/(V₂O₅×SnO₂)<15, preferably 8.0<Fe₂O₃/(V₂O₅×SnO₂)<15. Maintaining this balance enhances the optical properties of the glass-ceramic.

Silica (SiO₂) is the main glass former oxide. High contents will contribute to increasing the viscosity of the glass beyond what is acceptable, whereas excessively low contents will increase the thermal expansion coefficient. The silica content is preferably within a range extending from 52 to 75%, in particular from 64 to 70%, 65.0 to 70%.

Alumina (Al₂O₃) also contributes to an increase in the viscosity of the glass and thus makes it harder to melt. When it is present at too low levels, however, the glass is difficult to ceramize. The alumina content is preferably within a range extending from 18 to 27%, in particular from 18 to 21%.

Lithium oxide (Li₂O) is essential for the formation of β-quartz crystals. A minimum content level is also necessary in order to reduce the viscosity of the glass at high temperature. The Li₂O content is preferably within a range extending from 2.5 to 5.5%, in particular from 2.5 to 3.9%.

The soda (Na₂O) and potash (K₂O) contents are each preferably less than 3%, more preferentially less than 1.0%. The sum of these contents, denoted Na₂O+K₂O, is preferably limited to ensure a low coefficient of thermal expansion. This sum is advantageously at most 1.5%, or even 1%.

In order to ensure adequate viscosity at high temperature, making it possible to optimize both the melting and forming of the mother glass, the composition of the plate contains lime (CaO) and barium oxide (BaO). The CaO content is preferably at most 2.5%, more preferentially at most 1.0%, both to prevent excessive corrosion of the refractories of the furnace, and to limit the formation of potentially scattering crystals. The BaO content is preferably at most 3.5%, in particular at most 3%. The sum of the CaO and BaO contents (denoted CaO+BaO) is probably in range extending from 2 to 5%, in particular from 2.5 to 4%.

The MgO content is preferably no more than 3%. Contents between 0.20 and 1.5% are preferred.

The SrO content is preferably at most 2%, or even at most 1.4%. It is even advantageously zero.

The ZnO content is preferably at most 3.5% or even 1.2% to 2.8%. During ceramization, this oxide participates in the formation of the crystals of β-quartz structure, and therefore contributes to the lowering of the thermal expansion coefficient.

Titanium oxides (TiO₂) and zirconium (ZrO₂) serve as nucleating agents and promote bulk crystallization of the β-quartz structure crystals. The TiO₂ content is preferably from 1.2 to 5.5%, more preferentially from 1.8 to 3.2%. The ZrO₂ content is preferably less than 3%, more preferentially from 1.0 to 2.5. High ZrO₂ contents can lead to excessively high liquidus temperatures. The combined presence of TiO₂ and Zr₂ is advantageous. The sum of their contents (TiO₂+ZrO₂) is preferably greater than 3.80%, more preferentially greater than 4%. Low levels can encourage excessive crystal growth, resulting in undesirable light scattering.

The glass-ceramic plate according to the invention advantageously has a chemical composition comprising, in addition to SnO₂, V₂O₅, Fe₂O₃ and Cr₂O₃, the following constituents within the limits defined below expressed in weight percent:
SiO₂ 52 to 75%, preferably 64 to 70%
Al₂O₃ 18 to 27%, preferably 18 to 21%
Li₂O 2.5 to 5.5%, preferably 2.5 to 3.9%
K₂O 0 to 3%, preferably 0 to 1.0%
Na₂O 0 to 3%, preferably 0 to 1.0%
ZnO 0 to 3.5%, preferably 1.2 to 2.8%
MgO 0 to 3%, preferably 0.20 to 1.5%
CaO 0 to 2.5%, preferably 0 to 1.0%
BaO 0 to 3.5%, preferably 0 to 3%
SrO 0 to 2%, preferably 0 to 1.4%
TiO₂ 1.2 to 5.5%, preferably 1.8 to 3.2%
ZrO₂ 0 to 3%, preferably 1.0 to 2.5%
P₂O₅ 0 to 8%, preferably 0 to 3%

The chemical composition of the glass-ceramic plate comprises the oxides previously indicated. Preferably, it essentially consists of these oxides. The expression “consists essentially of” is understood to mean that the aforementioned oxides make up at least 96%, or even 98% or 99%, of the weight of the glass-ceramic. The chemical composition of glass-ceramic plates generally comprises only Fe2O3, V2O5 and Cr2O3 as pigments. Other pigments, such as MnO, Bi₂O₃, CoO, NiO or CeO₂, may be present in trace amounts, typically in a total content of less than 0.1%, or even less than 0.05% or even less than 0.01%. In particular, the chemical composition of the glass-ceramic plate typically comprises less than 10 ppm, or even less than 5 ppm, of CoO.

The glass-ceramic plate typically has a thickness of from 2 to 10 mm, in particular 2.5 to 8 mm, for example 3, 4, 5 or 6 mm. The dimensions (length and width) of the glass-ceramic sheet depend on the application for which it is intended: it generally has dimensions of from 20 to 120 cm, in particular for these applications in cooking devices, but may also have greater dimensions, for example greater than 200 cm, for worktop applications.

The glass-ceramic plate according to the invention typically has a light transmission of 0.5 to 8%, preferably from 0.7 to 6%. Light transmission is measured at the actual thickness of the glass-ceramic plate according to ISO 9050:2003. At actual thickness, it has an optical transmission at 625 nm of more than 3.5%, preferably more than 4%, an optical transmission at 950 nm of 40 to 70% and an optical transmission at 1600 nm of 45 to 75%.

The invention also relates to a lithium aluminosilicate-type glass plate, a precursor of the glass-ceramic plate according to the invention. The chemical composition of the glass plate is identical or substantially identical to that of the glass-ceramic plate according to the invention. The contents described above in relation to the composition of the glass-ceramic plate therefore also apply to the composition of the glass plate according to the invention. In particular, the glass plate preferably has a chemical composition which comprises the following constituents within the limits defined hereunder, expressed as weight percent:
SnO₂ 0.05 to <0.35%
V₂O₅ 0.05 to 0.40%
Fe₂O₃ >0.30 to 0.40%
Cr₂O₃ 0.005 to 0.04%.

The glass plate, on the other hand, is exclusively vitreous in nature, i.e. crystal-free. It should be noted that said precursor glasses advantageously have an optical transmission, for any wavelength between 1000 and 2500 nm, greater than 60%. This facilitates melting and refining.

A further object of the invention is a method of manufacturing a glass-ceramic plate according to the invention, comprising providing a glass plate according to the invention and ceramizing the glass plate. More specifically, providing the glass plate comprises a melting step and a forming step.

The melting is typically carried out in refractory furnaces with the aid of burners that use air or, better still, oxygen as oxidizer and natural gas or fuel oil as fuel. Resistors, in particular made of molybdenum or platinum, immersed in the molten glass may also provide some or all of the energy used to obtain molten glass. Raw materials (silica, spodumene, petalite, lithium carbonate, etc.) are introduced into the furnace and, under the effect of the high temperatures, undergo various chemical reactions, such as decarbonation reactions, actual melting reactions, etc. The maximum temperature reached by the glass is typically at least 1500° C., in particular between 1600 and 1700° C. The glass can be formed into plates in a known way by rolling of the glass between metal or ceramic rollers, by drawing (upward or downward), or else by the float process, a technique that involves pouring the molten glass onto a bath of molten tin.

The ceramization step preferably involves a thermal cycle implementing a temperature rise to a crystallization temperature preferably within a range from 850 to 1000° C., for example from 900 to 980° C., or even from 920 to 960° C. The choice of temperatures and/or of the ceramization times, to be adapted to each composition, makes it possible to adjust the thermal expansion coefficient of the material obtained by varying the size and the quantity of crystals. Preferably, the thermal cycle comprises a rise to a temperature between 650° C. and 850° C. for a duration of 15 to 200 minutes (nucleation step) and then a controlled rise to the crystallization temperature, typically for a duration of 5 to 120 minutes, followed by maintaining the crystallization temperature for a duration of 5 to 20 minutes (crystalline growth step).

Another object of the invention is an article, in particular a cooking device or worktop, comprising at least one glass-ceramic plate according to the invention.

The cooking device is preferably of the radiant or induction type. It is preferable for the plate to be able to conceal the heating means (for example the inductors), the electrical wiring, as well as the control and control circuits of the cooking device. To this end, it is possible to provide at least part of the plate surface with a coating deposited on and/or under the plate, said coating having the ability to absorb and/or reflect and/or scatter the light radiation. The coating may be deposited underneath the plate, that is to say on the surface facing the internal elements of the device, also referred to as the “lower face”, and/or on the plate, that is to say on the upper face. The coating may be an organic-based layer, such as a layer of paint, of resin, or of lacquer, or a mineral-based layer, such as an enamel or a metallic or metal oxide, nitride, oxynitride or oxycarbide layer. Preferably, the organic layers will be deposited on the lower face, whereas the mineral layers, especially the enamels, will be deposited on the upper face. Besides the glass-ceramic plate and at least one inductor (preferably three or four and even five), the cooking device may comprise at least one light-emitting device, at least one control and monitoring device, the assembly typically being in a housing. The light-emitting device(s) is (are) advantageously selected from liquid crystal displays (LCD), light-emitting diode displays (for example, 7-segment displays), possibly organic (OLED), fluorescent displays (VFD). These light-emitting devices can be purely decorative, for example visually separating different areas of the plate. Most often however they will have a functional role displaying various information useful for the user, especially indication of the heating power, of the temperature, of cooking programs, of cooking time, of zones of the plate exceeding a predetermined temperature. The control and monitoring devices generally comprise touch-sensitive controls, for example of the capacitive or infrared type. All of the internal elements are generally attached to a housing, often metallic, which therefore constitutes the lower part of the cooking device, normally concealed in the worktop or in the body of the cooker.

The following examples provide a non-limiting illustration of the invention.

Various glasses with the chemical composition (oxide content by weight) given in Table 1 were melted in a known manner, and a number of 4 mm thick mother glass plate samples were formed for each composition. The plates are then subjected to a ceramization treatment in different cycles, characterized by different ceramization temperatures T_{c} (925° C., 945° C. and 960° C.). Ceramization cycles involve rapid heating to 600° C., rising to 820° C. at a rate of 17° C./min, holding this level for 10 min, then rising to the ceramization temperature T_{c} at a rate of 17° C./min, holding the ceramization temperature T_{c} for 10 min, and finally controlled cooling of the glass-ceramic to room temperature.

The light transmission (Tv) is measures for each sample according to ISO standard 9050:2003. For a given mother glass composition, Tvₘₐₓ and Tvₘᵢₙ respectively represent the maximum and minimum light transmissions measured among the glass-ceramics obtained using the different ceramization cycles.

Table 1 below, summarizing the results achieved, indicates:
The composition of the mother glasses used;
The minimum light transmission Tvₘᵢₙ of the glass-ceramics obtained, as a function of the ceramization cycle, for a given mother glass composition;
The light transmission amplitude Tvₘₐₓ−Tvₘᵢₙ achieved with the three ceramization cycles.

TABLE 1

| | C1 | C2 | I1 |
|---|---|---|---|
| SiO₂ | 65.3 | 64.4 | 65.2 |
| Al₂O₃ | 20.6 | 21.04 | 20.6 |
| Li₂O | 3.75 | 3.80 | 3.63 |
| K₂O | 0.21 | 0.25 | 0.24 |
| Na₂O | 0.60 | 0.58 | 0.49 |
| ZnO | 1.50 | 1.51 | 1.39 |
| MgO | 0.37 | 0.33 | 0.40 |
| CaO | 0.48 | 0.42 | 0.44 |
| BaO | 2.50 | 2.53 | 2.40 |
| TiO₂ | 2.90 | 3.03 | 2.96 |
| ZrO₂ | 1.30 | 1.34 | 1.54 |
| SnO₂ | 0.31 | 0.36 | 0.25 |
| V₂O₅ | 0.023 | 0.09 | 0.11 |
| Fe₂O₃ | 0.14 | 0.24 | 0.36 |
| Cr₂O₅ | 0.024 | 0.022 | 0.013 |
| 1000 × (2 Fe − Sn) × V/2 | −0.3 | 5.4 | 25.9 |
| Tvₘᵢₙ (%) | 1.4 | 0.97 | 1.17 |
| Tvₘₐₓ − Tvₘᵢₙ (%) | 0.9 | 2.0 | 4.6 |

These results show that the compositions of according to the invention make it possible to achieve a wider range of light transmission, useful in particular for applications as a cooking plate, with the same mother glass composition. This makes it possible to adapt optical properties to different specifications without having to modify the composition of the mother glass.

1. A lithium aluminosilicate-type glass-ceramic plate, wherein said plate has a chemical composition comprising the following constituents in the following weight percents:
SnO₂ 0.05 to <0.35%
V₂O₅ 0.05 to 0.40%
Fe₂O₃ >0.32 to 0.40%
Cr₂O₃ 0.005 to 0.040%, and
wherein the SnO₂, V₂O₅ and Fe₂O₃ contents satisfy
14<1000×(2 Fe₂O₃—SnO₂)×V₂O₅/2<40.

2. The glass-ceramic plate according to claim 1, wherein the SnO₂, V₂O₅ and Fe₂O₃ contents satisfy
20<1000×(2 Fe₂O₃—SnO₂)×V₂O₅/2<35.

3. The glass-ceramic plate according to claim 1, having a V₂O₅ content of 0.07 to 0.30%.

4. The glass-ceramic plate according to claim 1, having an Fe₂O₃ content of 0.35 to 0.40%.

5. The glass-ceramic plate according to claim 1, having an SnO₂ content of 0.10 to 0.32%.

6. The glass-ceramic plate according to claim 1, having a Cr₂O₃ content of 0.010 to 0.032%.

7. The glass-ceramic plate according to claim 1, wherein the contents of SnO₂, V₂O₅ et Fe₂O₃ satisfy:
7.0<Fe₂O₃/(V₂O₅×SnO₂)<15.

8. The glass-ceramic plate according to claim 1, wherein the chemical composition comprises the following constituents in the following weight percents:
SiO₂ 52 to 75%,
Al₂O₃ 18 to 27%,
Li₂O 2.5 to 5.5%,
K₂O 0 to 3%,
Na₂O 0 to 3%,
ZnO 0 to 3.5%,
MgO 0 to 3%,
CaO 0 to 2.5%,
BaO 0 to 3.5%,
SrO 0 to 2%,
TiO₂ 1.2 to 5.5%,
ZrO₂ 0 to 3%,
P₂O₅ 0 to 8%.

9. An article, comprising a glass-ceramic plate as defined in claim 1.

10. A lithium aluminosilicate-type glass plate, wherein said plate has a chemical composition comprising the following constituents in the following weight percents:
SnO₂ 0.05 to <0.35%
V₂O₅ 0.05 to 0.40%
Fe₂O₃ >0.32 to 0.40%
Cr₂O₃ 0.005 to 0.04%, and
wherein the SnO₂, V₂O₅ and Fe₂O₃ contents satisfy
14<1000×(2 Fe₂O₃—SnO₂)×V₂O₅/2<40.

11. A method for manufacturing the glass-ceramic plate according to claim 1 comprising ceramization of a lithium aluminosilicate-type glass plate that has a chemical composition comprising the following constituents in the following weight percents:
SnO₂ 0.05 to <0.35%
V₂O₅ 0.05 to 0.40%
Fe₂O₃ >0.32 to 0.40%
Cr₂O₃ 0.005 to 0.04%, and
wherein the SnO2. V205 and Fe203 contents satisfy
14<1000×(2 Fe₂O₃—SnO₂)×V₂O₅/2<40.

12. The glass-ceramic plate according to claim 1, having a V₂O₅ content of 0.10 to 0.20%.

13. The glass-ceramic plate according to claim 1, having an SnO₂ content of 0.15 to 0.30%.

14. The glass-ceramic plate according to claim 1, having a Cr₂O₃ content of 0.012 to 0.030%.

15. The glass-ceramic plate according to claim 1, wherein the contents of SnO₂, V₂O₅ et Fe₂O₃ satisfy:
8.0<Fe₂O₃/(V₂O₅×SnO₂)<15.

16. The glass-ceramic plate according to claim 1, wherein the chemical composition comprises the following constituents in the following weight percents:
SiO₂ 65.0 to 70%
Al₂O₃ 18 to 21%
Li₂O 2.5 to 3.9%
K₂O 0 to 1.0%
Na₂O 0 to 1.0%
ZnO 1.2 to 2.8%
MgO 0.20 to 1.5%
CaO 0 to 1.0%
BaO 0 to 3%
SrO 0 to 1.4%
TiO₂ 1.8 to 3.2%
ZrO₂ 1.0 to 2.5%
P₂O₅ 0 to 3%.

17. The glass-ceramic plate according to claim 1, having a V₂O₅ content of 0.10 to 0.20%, an Fe₂O₃ content of 0.35 to 0.40%, an SnO₂ content of 0.15 to 0.30%, a Cr₂O₃ content of 0.012 to 0.030%, and wherein the contents of SnO₂, V₂O₅ et Fe₂O₃ satisfy:
8.0<Fe₂O₃/(V₂O₅×SnO₂)<15.
